(19) United States
(12) Patent Application Publication
(10) Pub. No.: US 2013/0003494 A1
(43) Pub. Date: Jan. 3, 2013

(54) INLINE STATIC MIXER

(75) Inventor: Thomas Allan Kirk, Hastings, MN (US)

(73) Assignee: NORDSON CORPORATION, Westlake, OH (US)

(21) Appl. No.: 13/575,496

(22) PCT Filed: Mar. 24, 2011
(86) PCT No.: PCT/US2011/029775

§ 371 Date: Jul. 26, 2012

Related U.S. Application Data
(60) Provisional application No. 61/317,531, filed on Mar. 25, 2010.

(51) Int. Cl. B01F 5/06

(52) U.S. Cl. 366/337

(57) ABSTRACT

A static mixer (10) for mixing a fluid flow includes a mixer conduit (12) and a plurality of mixer baffle segments (30, 32) configured to divide and rotate the fluid flow. Each of the mixer baffle segments (30, 32) may consist of a plurality of planar baffle plates (40, 42, 44, 50, 52, 54, 56) interconnected together to minimize complex geometries that are difficult to mold. The planar baffle plates may be connected by chamfered surfaces (66) to minimize sharp corners which damage sensitive fluids in the mixer conduit (12). Each mixer baffle segment (30, 32) may include three planar divider baffle plates (40, 42, 44) oriented parallel to the direction of flow (F) and four planar occluding baffle plates (50, 52, 54, 56) oriented perpendicular to the direction of flow (F). The static mixer (10) thoroughly mixes two or more fluids passing through the mixer conduit (12).

### CROSS-REFERENCE TO RELATED APPLICATION

This application claims the priority of U.S. Provisional Patent Application Ser. No. 61/317,531, filed on Mar. 25, 2010 (pending), the disclosure of which is incorporated by reference herein.

### TECHNICAL FIELD

This invention generally relates to static mixers for mixing two or more fluids in a fluid dispenser, and particularly to a static mixer configured to mix blood with one or more other fluids.

### BACKGROUND

A number of motionless mixer types exist, such as Multiflux, helical, and others. These mixer types, for the most part, implement the same general principle to mix fluids together. In these mixers, fluids are mixed together by dividing and recombining the fluids in an overlapping manner. This action is achieved by forcing the fluid over a series of baffles of alternating geometry. Such division and recombination causes the layers of the fluids being mixed to thin and eventually diffuse past one another. This mixing process has proven to be very effective, especially with high viscosity fluids.

Static mixers are typically constructed of a series of alternating baffles, of varying geometries, usually consisting of right-handed and left-handed mixing baffles disposed in a conduit to perform the continuous division and recombination. Such mixers are generally effective in mixing together most of the mass fluid flow, but these mixers typically include a plurality of baffles with complex geometry and shapes. This complex geometry is difficult to produce in a molding process reliably and may not release properly from a mold, which leads to a significant amount of wasted material and increased cost. Additionally, the molding process may also result in irregularities and sharp features being formed throughout the baffles. These sharp features and complex baffles may adversely affect certain fluids passing through the static mixer. For example, static mixers are used in the medical field to mix blood with one or more other fluids before delivery to a patient. Conventional static mixers may destroy red blood cells in blood passing through the static mixer whenever the blood passes sharp or irregular features. As a result, the blood exiting the static mixer may not be suitable for the patient.

There is a need, therefore, for a static mixer that addresses these and other problems associated with conventional mixers.

### SUMMARY

In one embodiment of the invention, a static mixer for mixing a fluid flow includes a plurality of mixer baffle segments which may be positioned in a mixer conduit. The plurality of mixer baffle segments defines a direction of flow through the static mixer. The mixer baffle segments are configured to divide and rotate the fluid flow. Each of the mixer baffle segments consists of a plurality of planar baffle plates interconnected together to form pairs of adjacent baffle plates oriented generally perpendicular to each other along adjoining edges. The adjoining edges may be chamfered. As such, the plurality of mixer baffle segments is reliable to manufacture and minimizes the number of sharp corners that the fluid flow must pass through when being mixed in the static mixer.

Each of the mixer baffle segments may further include a plurality of planar divider baffle plates interconnected together and extending generally parallel to the direction of flow. The planar divider baffle plates divide the mixer conduit into four quadrants. Each of the mixer baffle segments may also include a plurality of planar occluding baffle plates interconnected to the plurality of planar divider baffle plates. The planar occluding baffle plates extend generally perpendicular to the direction of flow so as to occlude at least one of the four quadrants. The plurality of mixer baffle segments may include a first mixer baffle segment configured to rotate the fluid flow counter-clockwise in the direction of flow and a second mixer baffle segment configured to rotate the fluid flow clockwise in the direction of flow. The first and second mixer baffle segments may be arranged in alternating relation such that the fluid flow through the mixer conduit is divided and rotated in different directions through the mixer conduit.

In another embodiment of the invention, a static mixer for mixing a fluid flow includes a plurality of mixer baffle segments which may be disposed in a mixer conduit along a direction of flow. Each of the mixer baffle segments includes a first planar divider baffle plate having a first leading edge and a first trailing edge, a second planar divider baffle plate having a second leading edge and a second trailing edge, and a third planar divider baffle plate having a third leading edge and a third trailing edge. Each of the first, second, and third planar divider baffle plates extends parallel to the direction of flow, and the second planar divider baffle plate is coupled in perpendicular relationship with each of the first and third planar divider baffle plates. Thus, the first, second, and third planar divider baffle plates effectively divide the mixer conduit into first, second, third, and fourth quadrants.

Each of the mixer baffle segments also includes first, second, third, and fourth planar occluding baffle plates extending generally perpendicular to the direction of flow. The first planar occluding baffle plate is connected to the first trailing edge of the first planar divider baffle plate and the second leading edge of the second planar divider baffle plate so as to block flow in the first quadrant. The second planar occluding baffle plate is connected to the second trailing edge of the second planar divider baffle plate and the third leading edge of the third planar divider baffle plate so as to block flow in the second quadrant. The third planar occluding baffle plate is connected to the first trailing edge of the first planar divider baffle plate and the second leading edge of the second planar divider baffle plate so as to block flow in the third quadrant. The fourth planar occluding baffle plate is connected to the second trailing edge of the second planar divider baffle plate and the third leading edge of the third planar divider baffle plate so as to block flow in the fourth quadrant. Certain adjoining edges of the planar divider baffle plates and planar occluding baffle plates may be chamfered, thereby minimizing the number of sharp corners for the fluid flow to traverse in the mixer conduit.

### BRIEF DESCRIPTION OF THE DRAWINGS

FIG. 1 is a perspective view of one embodiment of a static mixer with a portion of the conduit sidewall removed.

FIG. 2 is a perspective view of a sequence of interconnected alternating mixer baffle segments that may be used in the static mixer of FIG. 1.

FIG. 3A is a right-side perspective view of the first mixer baffle segment of FIG. 2.

FIG. 3B is a left-side perspective view of the first mixer baffle segment of FIG. 3A.

FIG. 3C is a top view of the first mixer baffle segment of FIG. 3A.

FIG. 3D is a schematic illustration of the fluid flow through various points in the first mixer baffle segment of FIG. 3C.

FIG. 4A is a right-side perspective view of the second mixer baffle segment of FIG. 2.

FIG. 4B is a left-side perspective view of the second mixer baffle segment of FIG. 4A.

FIG. 4C is a top view of the second mixer baffle segment of FIG. 4A.

FIG. 4D is a schematic illustration of the fluid flow through various points in the second mixer baffle segment of FIG. 4C.

### DETAILED DESCRIPTION

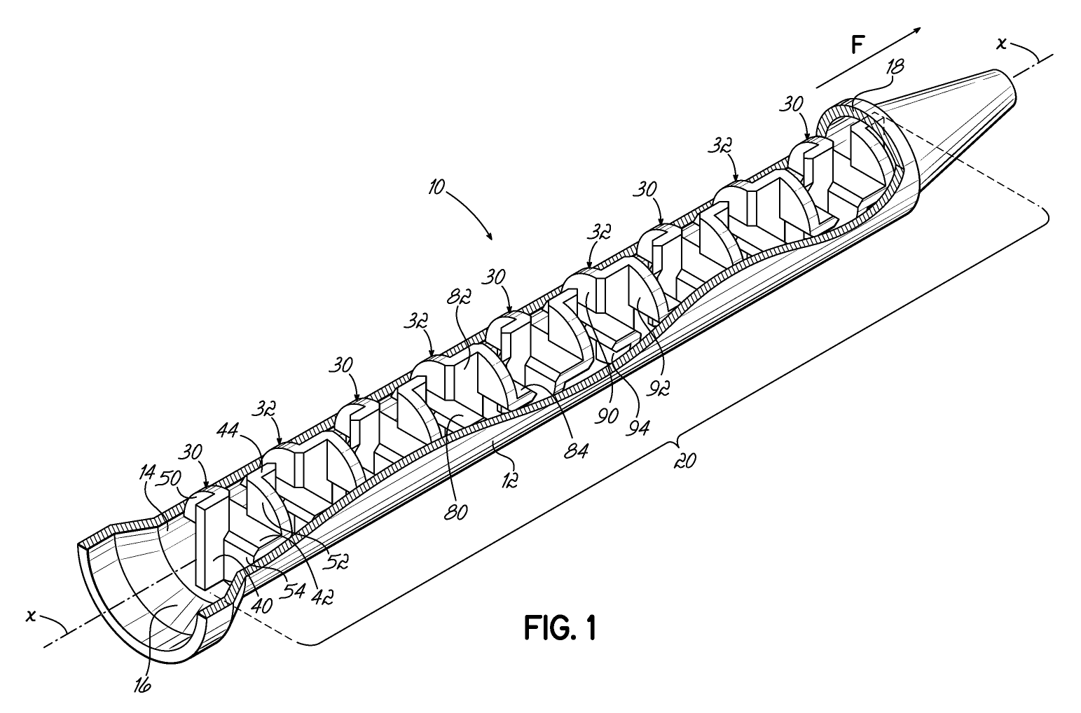

FIGS. 1-4D illustrate one embodiment of a static mixer 10 in accordance with one embodiment of the invention. As shown in FIG. 1, the static mixer 10 includes a mixer conduit 12 defining an interior wall 14, an inlet end 16, and an outlet end 18. The mixer conduit 12 includes a longitudinal axis x extending from the inlet end 16 to the outlet end 18. The static mixer 10 also includes a mixer baffle segment stack 20 including a plurality of mixer baffle segments 30, 32 interconnected to each other and disposed in the mixer conduit 12. The plurality of mixer baffle segments 30, 32 includes a first mixer baffle segment 30 configured to divide the fluid flow through the mixer conduit 12 and rotate the fluid flow counterclockwise in a direction of flow F. The plurality of mixer baffle segments 30, 32 further includes a second mixer baffle segment 32 configured to divide the fluid flow and rotate the fluid flow clockwise in the direction of flow F through the mixer conduit 12.

The static mixer 12 shown in FIG. 1 is a nine-stage mixer including nine total mixer baffle segments 30, 32 in the mixer baffle segment stack 20. More specifically, the mixer baffle segment stack 20 includes five first mixer baffle segments 30 and four second mixer baffle segments 32 in alternating relationship. A person having skill in the art will recognize that a different number of total mixer baffle segments may be used in the mixer baffle segment stack 20 for differing lengths of the static mixer 10 without departing from the scope of the invention. Additionally, the ratio of first mixer baffle segments 30 to second mixer baffle segments 32 may also be modified without departing from the scope of the invention. Fluids inserted into the mixer conduit 12 flow along a general direction of flow indicated by arrow F. As a multi-component fluid flow passes through the mixer conduit 12, the plurality of mixer baffle segments 30, 32 induces mixing together of two or more components of the fluid flow.

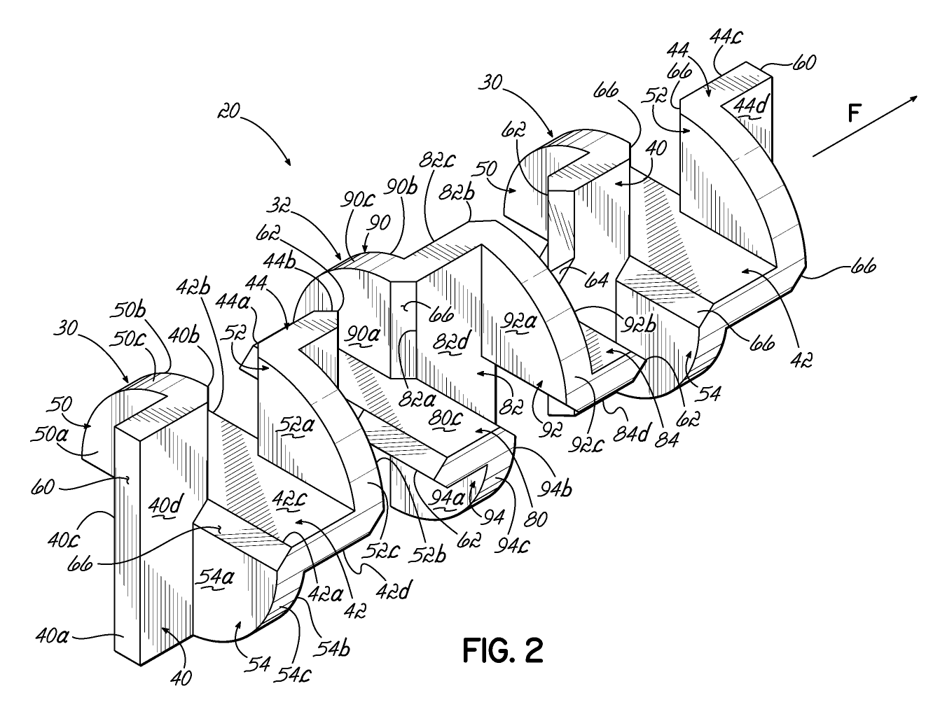

FIG. 2 further shows a shortened version of the mixer baffle segment stack 20 shown in FIG. 1. The mixer baffle segment stack 20 again includes at least one first mixer baffle segment 30 and at least one second mixer baffle segment 32 in alternating relationship. As shown in FIG. 2, the plurality of mixer baffle segments 30,32 may consist of a plurality of planar baffle plates interconnected together to form pairs of adjacent baffle plates that are generally perpendicular to one another. The planar shape of the plurality of baffle plates is configured to reliably release from a mold in an injection molding process when injection molding is used to manufacture the mixer baffle segments 30, 32. Additionally, the plurality of planar baffle plates may be chamfered along adjoining edges to minimize the number of sharp corners present in a mixer baffle segment 30, 32. Because each of the baffle plates is shaped to be planar in the illustrated embodiment, each mixer baffle segment 30, 32 is easy to manufacture and reduces the number of sharp features and irregularities that may damage fluid flow passing through the mixer baffle segment 30, 32.

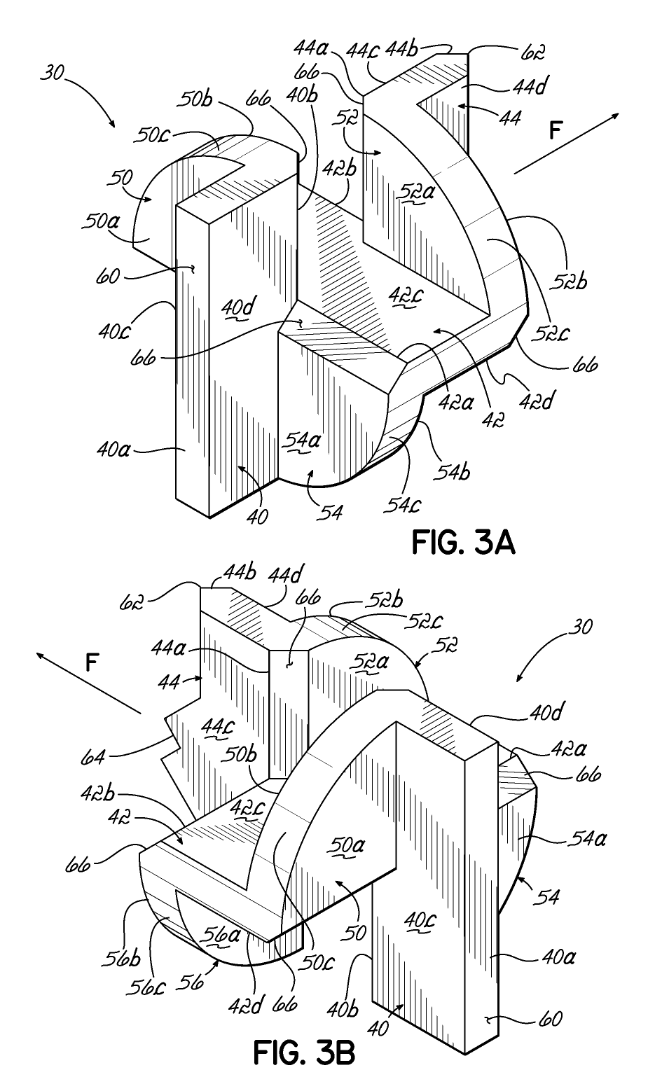

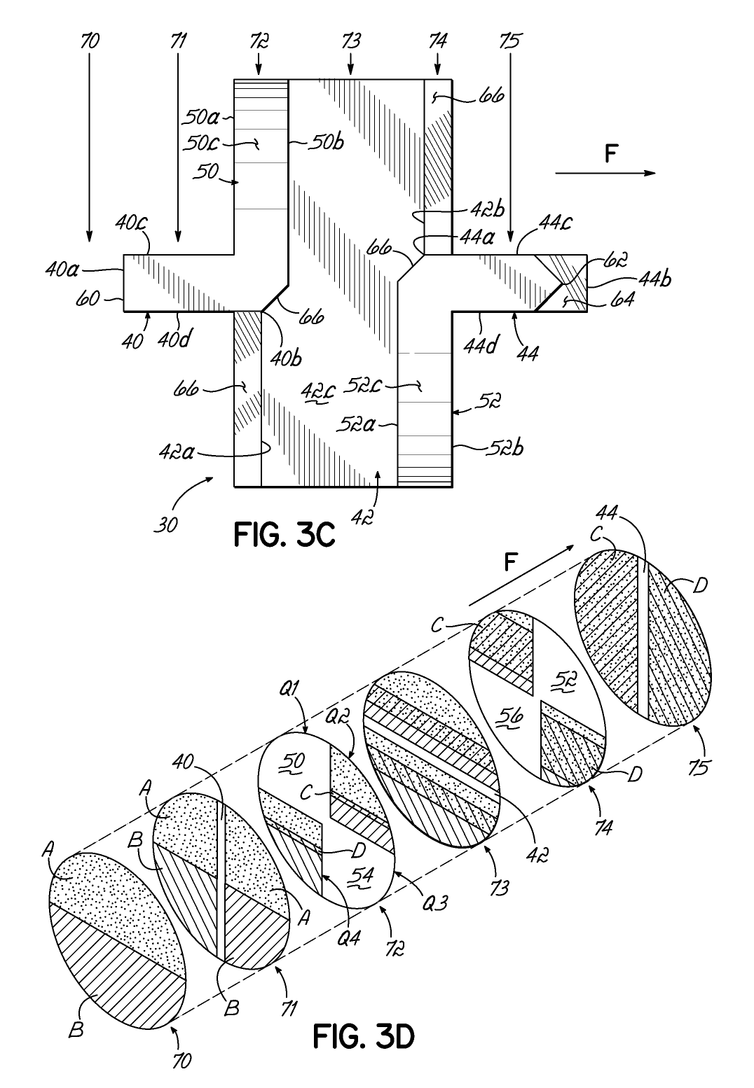

FIGS. 3A-3D illustrate the first mixer baffle segment 30 in further detail. As described above, the first mixer baffle segment 30 is configured to divide the fluid flow and rotate the fluid flow in a counterclockwise direction as the fluid flow passes along the direction of flow F. The first mixer baffle segment 30 includes a plurality of planar divider baffle plates 40, 42, 44 interconnected together and extending generally parallel to the direction of flow F. The plurality of planar divider baffle plates 40, 42, 44 divides the mixer conduit 12 into first, second, third and fourth quadrants Q1, Q2, Q3, Q4 as viewed along the direction of flow F. The first mixer baffle segment 30 also includes a plurality of planar occluding baffle plates 50, 52, 54, 56 interconnected to the plurality of planar divider baffle plates 40, 42, 44. Each of the plurality of planar occluding baffle plates 50, 52, 54, 56 extends generally perpendicular to the direction of flow F such that each of the planar occluding baffle plates 50, 52, 54, 56 occludes at least one of the quadrants Q1, Q2, Q3, Q4. In the following description of the baffle plates, directional terms such as vertical, horizontal, left, right, upper, and lower are provided for illustration purposes only and do not limit the actual orientation of these baffle plates within the mixer conduit 12 of the static mixer 10.

As more clearly shown in FIGS. 3A and 3B, the first mixer baffle segment 30 includes a first planar divider baffle plate 40 extending parallel to the direction of flow F in a generally vertical orientation. The first planar divider baffle plate 40 includes a first leading edge 40a, a first trailing edge 40b, a left side 40c, and a right side 40d. The first mixer baffle segment 30 further includes a second planar divider baffle plate 42 oriented perpendicular to the first planar divider baffle plate 40. In this regard, the second planar divider baffle plate 42 is oriented generally horizontally in the illustrated embodiment. The second planar divider baffle plate 42 includes a second leading edge 42a, a second trailing edge 42b, an upper side 42c, and a lower side 42d. The second leading edge 42a of the second planar divider baffle plate 42 is coupled to the first trailing edge 40b of the first planar divider baffle plate 40. The first mixer baffle segment 30 further includes a third planar divider baffle plate 44 oriented perpendicular to the second planar divider baffle plate 42. To this end, the third planar divider baffle plate 44 is oriented generally vertically in the illustrated embodiment. The third planar divider baffle plate 44 includes a third leading edge 44a, a third trailing edge 44b, a left side 44c, and a right side 44d. The third leading edge 44a of the third planar divider baffle plate 44 is coupled to the second trailing edge 42b of the second planar divider baffle plate 42.

As briefly described above, the first, second, and third planar divider baffle plates 40, 42, 44 divide the mixer conduit (not shown in FIG. 3A) into a first quadrant Q1, a second quadrant Q2, a third quadrant Q3, and a fourth quadrant Q4. In accordance with the illustrated embodiment, a baffle plate described as being disposed generally vertically divides the first and fourth quadrants Q1, Q4 of the mixer conduit 12 from the second and third quadrants Q2, Q3 of the mixer conduit 12, while a mixer baffle plate disposed in a generally horizontal direction divides the first and second quadrants Q1, Q2 of the mixer conduit 12 from the third and fourth quadrants Q3, Q4 of the mixer conduit 12.

The first mixer baffle segment 30 further includes a first planar occluding baffle plate 50 extending perpendicular to the direction of flow F. The first planar occluding baffle plate 50 is coupled to the second leading edge 42a of the second planar divider baffle plate 42 and the first trailing edge 40b of the first planar divider baffle plate 40. The first planar occluding baffle plate 50 includes a front side 50a, a rear side 50b, and an outer edge 50c configured to abut the interior wall 14 of the mixer conduit 12. In this regard, the first planar occluding baffle plate 50 extends above the upper side 42c of the second planar divider baffle plate 42 and to the left of the left side 40c of the first planar divider baffle plate 40 such that the first planar occluding baffle plate 50 blocks fluid flow in the first quadrant Q1. As explained in further detail below, the first planar occluding baffle plate 50 forces fluid flow on the left side 40c of the first planar divider baffle plate 40 below the second planar divider baffle plate 42.

The first mixer baffle segment 30 also includes a second planar occluding baffle plate 52 extending perpendicular to the direction of flow F. The second planar occluding baffle plate 52 is coupled to the second trailing edge 42b of the second planar divider baffle plate 42 and the third leading edge 44a of the third planar divider baffle plate 44. The second planar occluding baffle plate 52 includes a front side 52a , a rear side 52b, and an outer edge 52c configured to reside adjacent the interior wall 14 of the mixer conduit 12. The second planar occluding baffle plate 52 extends above the upper side 42c of the second planar divider baffle plate 42 and to the right of the right side 44d of the third planar divider baffle plate 44. The second planar occluding baffle plate 52 blocks fluid flow in the second quadrant Q2. Again as explained below, the second planar occluding baffle plate 52 forces fluid flow above the upper side 42c of the second planar divider baffle plate 42 to the left of the third planar divider baffle plate 44.

The first mixer baffle segment 30 further includes a third planar occluding baffle plate 54 extending generally perpendicular to the direction of flow F. The third planar occluding baffle plate 54 is coupled to the second leading edge 42a of the second planar divider baffle plate 42 and the first trailing edge 40b of the first planar divider baffle plate 40. The third planar occluding baffle plate 54 includes a front side 54a, a rear side 54b, and an outer edge 54c configured to reside adjacent the interior wall 14 of the mixer conduit 12. The third planar occluding baffle plate 54 extends below the lower side 42d of the second planar divider baffle plate 42 and to the right of the right side 40d of the first planar divider baffle plate 40. Therefore, the third planar occluding baffle plate 54 blocks fluid flow in the third quadrant Q3. To this end, the third planar occluding baffle plate 54 forces fluid flow to the right of the first planar divider baffle plate 40 above the second planar divider baffle plate 42.

The first mixer baffle segment 30 also includes a fourth planar occluding baffle plate 56 extending generally perpendicular to the direction of flow F. The fourth planar occluding baffle plate 56 is coupled to the second trailing edge 42b of the second planar divider baffle plate 42 and the third leading edge 44a of the third planar divider baffle plate 44. The fourth planar occluding baffle plate 56 includes a front side 56a, a rear side 56b, and an outer edge 56c configured to abut the interior wall 14 of the mixer conduit 12. The fourth planar occluding baffle plate 56 extends generally below the lower side 42d of the second planar divider baffle plate 42 and to the left of the left side 44c of the third planar divider baffle plate 44. Consequently, the fourth planar occluding baffle plate 56 blocks fluid flow in the fourth quadrant Q4. In this regard, the fourth planar occluding baffle plate 56 forces fluid flow below the lower side 42d of the second planar divider baffle plate 42 to the right of the third planar divider baffle plate 44.

As shown in FIGS. 3A and 3B, the first leading edge 40a of the first planar divider baffle plate 40 may include a flat rectangular dividing face 60. The flat rectangular dividing face 60 is configured to closely abut one of the inlet end 16 and the outlet end 18 of the mixer conduit 12. The third trailing edge 44b of the third planar divider baffle plate 44 further includes a sharp dividing edge 62 configured to facilitate division or recombination of the fluid flow in the mixer conduit 12. It will be appreciated that the first leading edge 40a of the first planar divider baffle plate 40 may include a sharp dividing edge 62 instead of a flat rectangular dividing face 60 in some embodiments (e.g., when the first leading edge 40a is not configured to be disposed adjacent the inlet end 16 or the outlet end 18 of the mixer conduit 12). Likewise, it will be appreciated that the third trailing edge 44b of the third planar divider baffle plate 44 may include a flat rectangular dividing face 60 instead of a sharp dividing edge 62 in some embodiments (e.g., when the third trailing edge 44b is configured to be disposed adjacent the inlet end 16 or the outlet end 18 of the mixer conduit 12). Additionally, the third trailing edge 44b of the third planar divider baffle plate 44 further includes a mating detent 64 formed along the sharp dividing edge 62 as shown in FIG. 3B. This mating detent 64 is configured to receive a sharp dividing edge 62 on a first leading edge of another mixer baffle segment 32 as shown previously in FIG. 2.

As described previously, the plurality of planar baffle plates 40, 42, 44, 50, 52, 54, 56 may be chamfered along certain adjoining edges to minimize the number of sharp corners encountering the flow passing through the static mixer 10. For example, a chamfered surface 66 may be formed at the adjoining edge of the upper side 42c of the second planar divider baffle plate 42 and the front side 54a of the third planar occluding baffle plate 54. In another example, a chamfered surface 66 may be formed between the front side 52a of the second planar occluding baffle plate 52 and the left side 44c of the third planar divider baffle plate 44. Likewise, another chamfered surface 66 may be formed between the right side 40d of the first planar divider baffle plate 40 and the rear side 50b of the first planar occluding baffle plate 50. Additionally, another chamfered surface 66 may be formed between the upper side 42c of the second planar divider baffle plate 42 and the rear side 56b of the fourth planar occluding baffle plate 56. It will be understood that additional chamfered surfaces 66 may be formed along any adjoining edges of any pair of adjacent baffle plates without departing from the scope of this invention.

FIGS. 3C and 3D further illustrate a schematic example of the flow of two fluids passing through the first mixer baffle segment 30. More particularly, FIG. 3C shows a top view of the first mixer baffle segment 30 and indicates various locations 70, 71, 72, 73, 74, 75 associated with the schematic cross-sectional views of the fluid flow in FIG. 3D. As shown at the first cross section of the flow (at 70) in FIG. 3D, the fluid flow entering the first mixer baffle segment 30 includes a first fluid A and a second fluid B. At the second cross section of the flow (at 71) in FIG. 3D, the first planar divider baffle plate 40 divides the fluid flow into two portions, a first flow portion in the first and fourth quadrants Q1, Q4 and a second flow portion in the second and third quadrants Q2, Q3. The third cross section of the fluid flow (at 72) in FIG. 3D illustrates the first planar occluding baffle plate 50 forcing the first flow portion below the lower side 42d of the second planar divider baffle plate 42. Furthermore, the third cross section of the fluid flow (at 72) shown in FIG. 3D further illustrates that the third planar occluding baffle plate 54 forces the second flow portion to move above the upper side 42c of the second planar divider baffle plate 42.

The fourth cross section of the fluid flow (at 73) shown in FIG. 3D illustrates the expansion of the first flow portion below the second planar divider baffle plate 42 and the expansion of the second flow portion above the second planar divider baffle plate 42. At the fifth cross section of the fluid flow (at 74) as shown in FIG. 3D, the second planar occluding baffle plate 52 forces the second flow portion to the left of the left side 44c of the third planar divider baffle plate 44. Likewise, the fifth cross section of the fluid flow (at 74) as shown in FIG. 3D also illustrates that the fourth planar occluding baffle plate 56 forces the first flow portion to move to the right of the right side 44d of the third planar divider baffle plate 44. As the flow rotates through these baffle plates, the first and second fluids A, B are continuously mixing as indicated schematically in FIG. 3D. Thus, at the sixth cross section of the fluid flow (at 75) shown in FIG. 3D, the first flow portion has expanded along the right side 44d of the third planar divider baffle plate 44 with the first and second fluids A, B mixed together. Similarly, the second flow portion has expanded along the left side 44c of the third planar divider baffle plate 44 with the first and second fluids A, B mixed together.

In sum, the first mixer baffle segment 30 has rotated the flow 180 degrees counter-clockwise in the direction of flow F and mixed the first and second fluids A, B together. The fluid flow passes a minimized number of sharp corners because of the inclusion of the various chamfered surfaces 66. Consequently, a sensitive fluid such as blood may avoid significant damage to red blood cells or other components during passage through the static mixer 10. Furthermore, the planar shape of each of the baffle plates 40, 42, 44, 50, 52, 54, 56 provides a non-complex overall geometry that is easy to manufacture in an injection molding process or other known process. In this regard, the first mixer baffle segment 30 reliably releases from a mold without irregularities or sharp features being added to the first mixer baffle segment 30. In embodiments where the first mixer baffle segment 30 is injection molded, the baffle plates are formed from materials that meet ISO-10993 test requirements for levels of toxicity. For example, the baffle plates may be composed of a thermoplastic polymer such as polypropylene or ABS (acrylonitrile butadiene styrene).

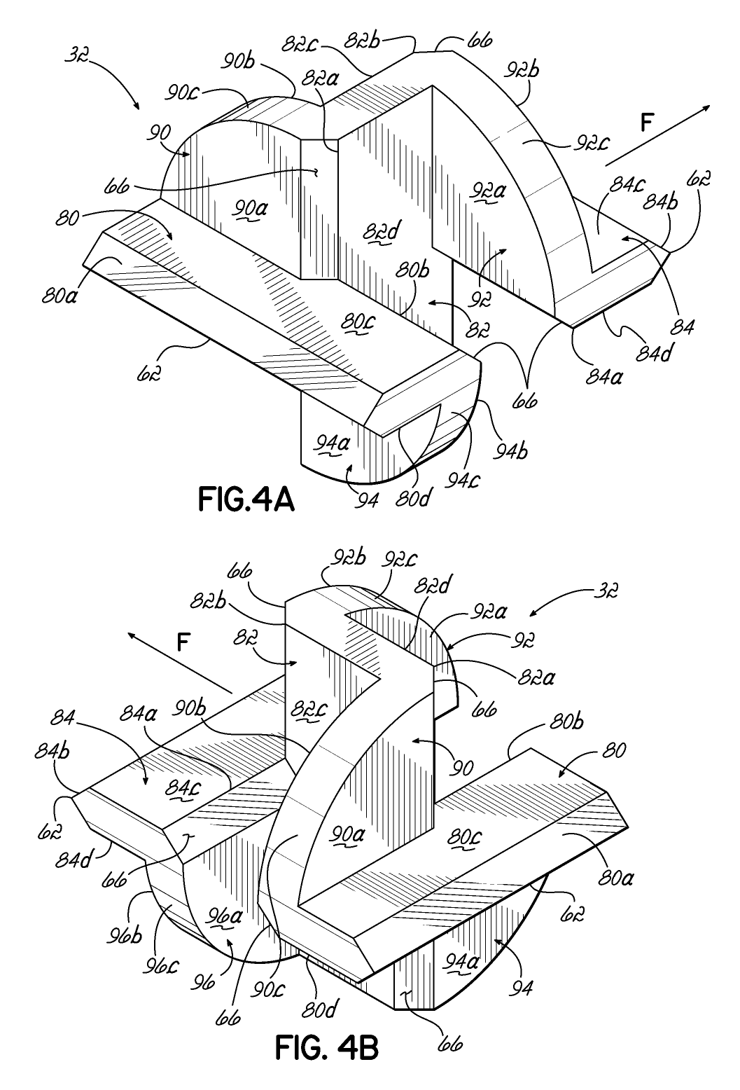

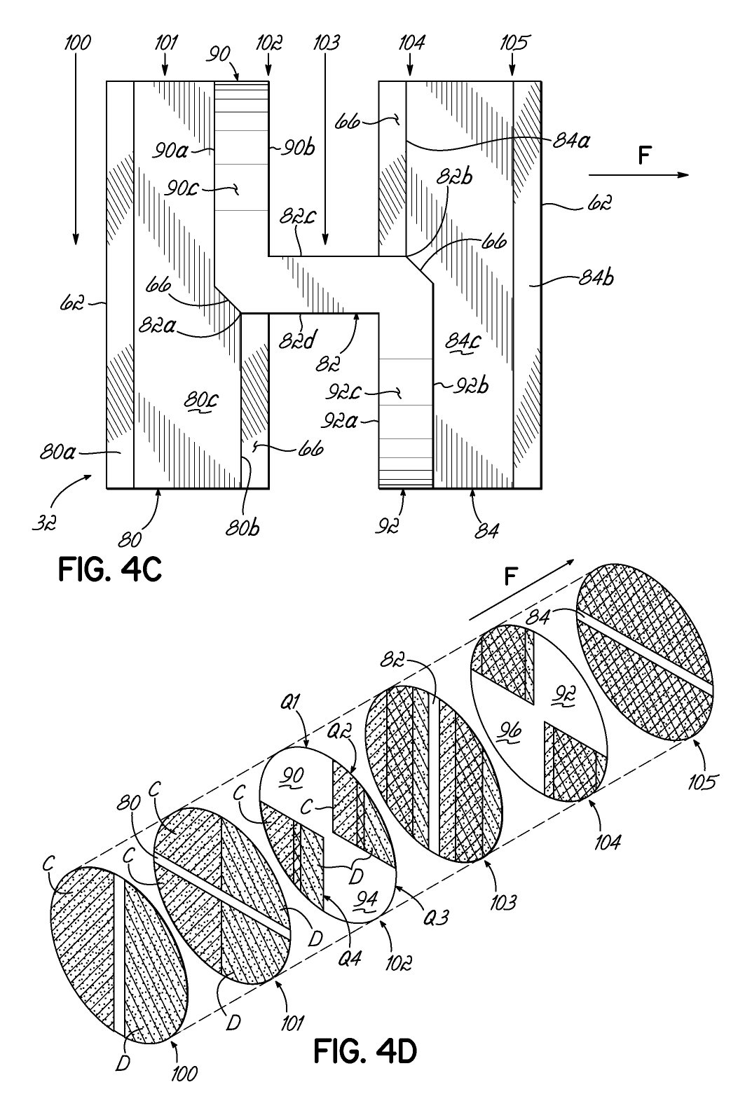

FIGS. 4A-4D illustrate the second mixer baffle segment 32 in further detail. As described above, the second mixer baffle segment 32 is configured to divide the fluid flow and rotate the fluid flow in a clockwise direction as the fluid flow passes along the direction of flow F. The second mixer baffle segment 32 includes a plurality of planar divider baffle plates 80, 82, 84 interconnected together and extending generally parallel to the direction of flow F. Once again, the plurality of planar divider baffle plates 80, 82, 84 divides the mixer conduit 12 into the first, second, third and fourth quadrants Q1, Q2, Q3, Q4 as viewed along the direction of flow F. The second mixer baffle segment 32 also includes a plurality of planar occluding baffle plates 90, 92, 94, 96 interconnected to the plurality of planar divider baffle plates 80, 82, 84. Each of the plurality of planar occluding baffle plates 90, 92, 94, 96 extends generally perpendicular to the direction of flow F such that each of the planar occluding baffle plates 90, 92, 94, 96 occludes at least one of the quadrants Q1, Q2, Q3, Q4.

As more clearly shown in FIGS. 4A and 4B, the second mixer baffle segment 32 includes a first planar divider baffle plate 80 extending parallel to the direction of flow F in a generally horizontal orientation. The first planar divider baffle plate 80 includes a first leading edge 80a, a first trailing edge 80b, an upper side 80c, and a lower side 80d. The second mixer baffle segment 32 further includes a second planar divider baffle plate 82 oriented perpendicular to the first planar divider baffle plate 80. In this regard, the second planar divider baffle plate 82 is oriented generally vertically in the illustrated embodiment. The second planar divider baffle plate 82 includes a second leading edge 82a, a second trailing edge 82b, a left side 82c, and a right side 82d. The second leading edge 82a of the second planar divider baffle plate 82 is coupled to the first trailing edge 80b of the first planar divider baffle plate 80. The second mixer baffle segment 32 further includes a third planar divider baffle plate 84 oriented perpendicular to the second planar divider baffle plate 82. To this end, the third planar divider baffle plate 84 is oriented generally horizontally in the illustrated embodiment. The third planar divider baffle plate 84 includes a third leading edge 84a, a third trailing edge 84b, an upper side 84c, and a lower side 84d. The third leading edge 84a of the third planar divider baffle plate 84 is coupled to the second trailing edge 82b of the second planar divider baffle plate 82.

The second mixer baffle segment 32 further includes a first planar occluding baffle plate 90 extending perpendicular to the direction of flow F. The first planar occluding baffle plate 90 is coupled to the second leading edge 82a of the second planar divider baffle plate 82 and the first trailing edge 80b of the first planar divider baffle plate 80. The first planar occluding baffle plate 90 includes a front side 90a, a rear side 90b, and an outer edge 90c configured to abut the interior wall 14 of the mixer conduit 12. In this regard, the first planar occluding baffle plate 90 extends above the upper side 80c of the first planar divider baffle plate 80 and to the left of the left side 82c of the second planar divider baffle plate 82 such that the first planar occluding baffle plate 90 blocks fluid flow in the first quadrant Q1. As explained in further detail below, the first planar occluding baffle plate 90 forces fluid flow above the upper side 80c of the first planar divider baffle plate 80 to the right of the second planar divider baffle plate 82.

The second mixer baffle segment 32 also includes a second planar occluding baffle plate 92 extending perpendicular to the direction of flow F. The second planar occluding baffle plate 92 is coupled to the second trailing edge 82b of the second planar divider baffle plate 82 and the third leading edge 84a of the third planar divider baffle plate 84. The second planar occluding baffle plate 92 includes a front side 92a, a rear side 92b, and an outer edge 92c configured to reside adjacent the interior wall 14 of the mixer conduit 12. The second planar occluding baffle plate 92 extends above the upper side 84c of the third planar divider baffle plate 84 and to the right of the right side 82d of the second planar divider baffle plate 82. The second planar occluding baffle plate 92 blocks fluid flow in the second quadrant Q2. Thus, the second planar occluding baffle plate 92 forces fluid flow on the right side 82d of the second planar divider baffle plate 82 below the third planar divider baffle plate 84.

The second mixer baffle segment 32 further includes a third planar occluding baffle plate 94 extending generally perpendicular to the direction of flow F. The third planar occluding baffle plate 94 is coupled to the second leading edge 82a of the second planar divider baffle plate 82 and the first trailing edge 80b of the first planar divider baffle plate 80. The third planar occluding baffle plate 94 includes a front side 94a, a rear side 94b, and an outer edge 94c configured to reside adjacent the interior wall 14 of the mixer conduit 12. The third planar occluding baffle plate 94 extends below the lower side 80d of the first planar divider baffle plate 80 and to the right of the right side 82d of the second planar divider baffle plate 82. Therefore, the third planar occluding baffle plate 94 blocks fluid flow in the third quadrant Q3. To this end, the third planar occluding baffle plate 94 forces fluid flow below the first planar divider baffle plate 80 to the left of the second planar divider baffle plate 82.

The second mixer baffle segment 32 also includes a fourth planar occluding baffle plate 96 extending generally perpendicular to the direction of flow F. The fourth planar occluding baffle plate 96 is coupled to the second trailing edge 82b of the second planar divider baffle plate 82 and the third leading edge 84a of the third planar divider baffle plate 84. The fourth planar occluding baffle plate 96 includes a front side 96a, a rear side 96b, and an outer edge 96c configured to abut the interior wall 14 of the mixer conduit 12. The fourth planar occluding baffle plate 96 extends generally below the lower side 84d of the third planar divider baffle plate 84 and to the left of the left side 82c of the second planar divider baffle plate 82. Consequently, the fourth planar occluding baffle plate 96 blocks fluid flow in the fourth quadrant Q4. The fourth planar occluding baffle plate 96 forces fluid on the left side 82c of the second planar divider baffle plate 82 above the third planar divider baffle plate 84.

As shown in FIGS. 4A and 4B, the first leading edge 80a of the first planar divider baffle plate 80 and the third trailing edge 84b of the third planar divider baffle plate 84 may each include a sharp dividing edge 62. Alternatively, one or both of the first leading edge 80a and the third trailing edge 84b may include a flat rectangular dividing face 60 as explained in further detail above. The sharp dividing edges 62 may include mating detents 64 to mate with other sharp dividing edges 62 on other mixer baffle segments 30, 32 as will be understood from the previous discussion of FIG. 2. Also as described previously, the plurality of planar baffle plates 80, 82, 84, 90, 92, 94, 96 may be chamfered along certain adjoining edges to minimize the number of sharp corners encountering the flow passing through the static mixer 10.

FIGS. 4C and 4D further illustrate a schematic example of the flow of two fluids A, B passing through the second mixer baffle segment 32 after passing through the first mixer baffle segment 30. More particularly, FIG. 4C shows a top view of the second mixer baffle segment 32 and indicates various locations associated with the schematic cross-sectional views 100, 101, 102, 103, 104, 105 of the fluid flow in FIG. 4D. As shown at the first cross section of the flow (at 100) in FIG. 4D, the fluid flow entering the second mixer baffle segment 32 includes a first fluid mixture C and a second fluid mixture D previously shown exiting the first mixer baffle segment 30 in FIG. 3D. At the second cross section of the flow (at 101) in FIG. 4D, the first planar divider baffle plate 80 divides the fluid flow into two portions, a first flow portion in the first and second quadrants Q1, Q2 and a second flow portion in the third and fourth quadrants Q3, Q4. The third cross section of the fluid flow (at 102) in FIG. 4D illustrates the first planar occluding baffle plate 90 forcing the first flow portion to the right of the second planar divider baffle plate 82. Furthermore, the third cross section of the fluid flow (at 102) shown in FIG. 4D further illustrates that the third planar occluding baffle plate 94 forces the second flow portion to move to the left of the second planar divider baffle plate 82.

The fourth cross section of the fluid flow (at 103) shown in FIG. 4D illustrates the expansion of the first flow portion to the right of the second planar divider baffle plate 82 and the expansion of the second flow portion to the left of the second planar divider baffle plate 82. At the fifth cross section of the fluid flow (at 104) as shown in FIG. 4D, the second planar occluding baffle plate 92 forces the first flow portion below the third planar divider baffle plate 82. Likewise, the fifth cross section of the fluid flow (at 104) as shown in FIG. 4D also illustrates that the fourth planar occluding baffle plate 96 forces the second flow portion above the third planar divider baffle plate 84. As the flow rotates through these baffle plates 80, 82, 84, 90, 92, 94, 96, the first and second fluid mixtures C, D are continuously mixing as indicated schematically in FIG. 4D. Thus, at the sixth cross section of the fluid flow (at 105) shown in FIG. 4D, the first flow portion has expanded along the lower side 84d of the third planar divider baffle plate 84 with the first and second fluid mixtures C, D further mixed together. Similarly, the second flow portion has expanded along the upper side 84c of the third planar divider baffle plate 84 with the first and second fluid mixtures C, D further mixed together.

In sum, the second mixer baffle segment 32 has rotated the flow 180 degrees clockwise in the direction of flow and further mixed the first and second fluids A, B together. The fluid flow passes a minimized number of sharp corners because of the inclusion of the various chamfered surfaces 66. Consequently, a sensitive fluid such as blood may avoid significant damage to red blood cells or other components during passage through the static mixer 10. Furthermore, the planar shape of each of the baffle plates 80, 82, 84, 90, 92, 94, 96 provides a non-complex overall geometry that is easy to manufacture such as by injection molding a thermoplastic material.

The plurality of first and second mixer baffle segments 30, 32 may be integrally formed as a single mixer baffle segment stack 20 or may be separately molded and interconnected together to form the mixer baffle segment stack 20. In one example, the plurality of mixer baffle segments 30, 32 may be integrally formed by an injection molding process. Each mixer baffle segment 30, 32 defines a length of approximately 0.6 inches. Consequently, the mixer baffle segments 30, 32 may be interconnected together to fill any length of mixer conduit 12 such as a mixer conduit 12 having a length of 1.8 inches (like the mixer baffle segment stack 20 shown in FIG. 2), 2.4 inches, 3.0 inches, etc. The mixer baffle segment stack 20 may then be inserted into the mixer conduit 12 in either direction because the various first and second baffle segments 30, 32 are mirror images of each other. Therefore, the orientation of the mixer baffle segment stack 20 within the mixer conduit 12 is not relevant to the ability of the static mixer 10 to mix various fluids.

Advantageously, each of the planar baffle plates in each of the mixer baffle segments 30, 32 is shaped to be planar such that the plurality of mixer baffle segments 30, 32 does not include any complex geometries or irregular shapes. As a result, the plurality of mixer baffle segments 30, 32 reliably releases from a mold in an injection molding process, and irregularities in the static mixer 10 are reduced or eliminated. Therefore, the static mixer 10 of the embodiment illustrated in FIGS. 1-4D minimizes damage to sensitive fluids such as blood passed through the mixer conduit 12. To this end, blood passing through the static mixer 10 remains at a high enough quality to be injected into a patient.

While the present invention has been illustrated by the description of a specific embodiment thereof, and while the embodiment has been described in considerable detail, it is not intended to restrict or in any way limit the scope of the appended claims to such detail. The various features discussed herein may be used alone or in any combination. Additional advantages and modifications will readily appear to those skilled in the art. For example, the seven described baffle plates of each mixing baffle segment may be added to additional baffle plates in other embodiments of the static mixer. The invention in its broader aspects is therefore not limited to the specific details, representative apparatus and methods and illustrative examples shown and described. Accordingly, departures may be made from such details without departing from the scope or spirit of the general inventive concept.

What is claimed is:

1. A static mixer for mixing a fluid flow, comprising:
a plurality of mixer baffle segments configured to divide and rotate the fluid flow, each of the mixer baffle segments consisting of a plurality of planar baffle plates interconnected together to form pairs of adjacent baffle plates oriented generally perpendicular to each other along adjoining edges,
wherein the plurality of mixer baffle segments define a direction of flow through the static mixer, and the plurality of planar baffle plates comprises:
a plurality of planar divider baffle plates interconnected together and extending generally parallel to the direction of flow so as to effectively divide the mixer;
a plurality of planar occluding baffle plates interconnected to the plurality of planar divider baffle plates and extending generally perpendicular to the direction of flow so as to occlude the fluid flow; and
a plurality of chamfered surfaces at adjoining edges of the planar divider baffle plates and the planar occluding baffle plates, the plurality of chamfered surfaces minimizing the number of sharp corners encountering the fluid flow to thereby avoid damaging any sensitive fluids in the fluid flow.

2. The static mixer of claim 1, wherein the plurality of planar divider baffle plates effectively divide the mixer into first, second, third, and fourth quadrants; and the plurality of planar occluding baffle plates each occlude at least one of the quadrants.

3. The static mixer of claim 2, wherein the plurality of planar divider baffle plates further comprises:
a first planar divider baffle plate including a first leading edge and a first trailing edge;
a second planar divider baffle plate oriented perpendicular to the first planar divider baffle plate and including a second leading edge and a second trailing edge, the second leading edge coupled to the first trailing edge of the first planar divider baffle plate; and
a third planar divider baffle plate oriented perpendicular to the second planar divider baffle plate and including a third leading edge and a third trailing edge, the third leading edge coupled to the second trailing edge of the second planar divider baffle plate.

4. The static mixer of claim 3, wherein the plurality of planar occluding baffle plates further comprises:
a first planar occluding baffle plate coupled to the second leading edge of the second planar divider baffle plate and the first trailing edge of the first planar divider baffle plate, the first planar occluding baffle plate blocking fluid flow in the first quadrant;
a second planar occluding baffle plate coupled to the second trailing edge of the second planar divider baffle plate and the third leading edge of the third planar divider baffle plate, the second planar occluding baffle plate blocking fluid flow in the second quadrant;
a third planar occluding baffle plate coupled to the second leading edge of the second planar divider baffle plate and the first trailing edge of the first planar divider baffle plate, the third planar occluding baffle plate blocking fluid flow in the third quadrant; and
a fourth planar occluding baffle plate coupled to the second trailing edge of the second planar divider baffle plate and the third leading edge of the third planar divider baffle plate, the fourth planar occluding baffle plate blocking fluid flow in the fourth quadrant.

5. The static mixer of claim 4, wherein the plurality of mixer baffle segments includes a first mixer baffle segment wherein the first and third planar divider baffle plates are oriented generally vertically such that the first mixer baffle segment divides the fluid flow and rotates the fluid flow counter-clockwise in the direction of flow.

6. The static mixer of claim 5, wherein the plurality of mixer baffle segments includes a second mixer baffle segment adjacent to the first mixer baffle segment, wherein the first and third planar divider baffle plates of the second mixer baffle segment are oriented generally horizontally such that the second mixer baffle segment divides the fluid flow and rotates the fluid flow clockwise in the direction of flow.

7. The static mixer of claim 3, wherein at least one of the leading edge and the trailing edge of each of the plurality of planar divider baffle plates includes a sharp dividing edge configured to facilitate division or recombination of the fluid flow.

8. The static mixer of claim 3, further including a mixer conduit having the plurality of the mixer baffle segments disposed therein, and including an inlet end and an outlet end, and at least one of the first leading edge and the third trailing edge includes a flat rectangular dividing face configured to abut one of the inlet end or the outlet end.

9. The static mixer of claim 1, further comprising a mixer baffle segment stack including the plurality of mixer baffle segments interconnected to each other and disposed in a mixer conduit.

10. The static mixer of claim 9, wherein the plurality of mixer baffle segments are integral with each other in the mixer baffle segment stack.

11. A static mixer for mixing a fluid flow, comprising:
a plurality of mixer baffle segments disposed along a direction of flow and configured to divide and rotate the fluid flow, each of the mixer baffle segments further comprising:
a first planar divider baffle plate including a first leading edge and a first trailing edge, the first planar divider baffle plate extending generally parallel to the direction of flow;
a second planar divider baffle plate oriented perpendicular to the first planar divider baffle plate and including a second leading edge and a second trailing edge, the second leading edge coupled to the first trailing edge of the first planar divider baffle plate, the second planar divider baffle plate extending generally parallel to the direction of flow;
a third planar divider baffle plate oriented perpendicular to the second planar divider baffle plate and including a third leading edge and a third trailing edge, the third leading edge coupled to the second trailing edge of the second planar divider baffle plate, the third planar divider baffle plate extending generally parallel to the direction of flow, the first, second, and third planar dividing baffle plates dividing the mixer into first, second, third, and fourth quadrants in the direction of flow;
a first planar occluding baffle plate coupled to the second leading edge of the second planar divider baffle plate and the first trailing edge of the first planar divider baffle plate, the first planar occluding baffle plate extending perpendicular to the direction of flow to block fluid flow in the first quadrant;
a second planar occluding baffle plate coupled to the second trailing edge of the second planar divider baffle plate and the third leading edge of the third planar divider baffle plate, the second planar occluding baffle plate extending perpendicular to the direction of flow to block fluid flow in the second quadrant;
a third planar occluding baffle plate coupled to the second leading edge of the second planar divider baffle plate and the first trailing edge of the first planar divider baffle plate, the third planar occluding baffle plate extending perpendicular to the direction of flow to block fluid flow in the third quadrant; and
a fourth planar occluding baffle plate coupled to the second trailing edge of the second planar divider baffle plate and the third leading edge of the third planar divider baffle plate, the fourth planar occluding baffle plate extending perpendicular to the direction of flow to block fluid flow in the fourth quadrant.

12. The static mixer of claim 11, wherein the plurality of mixer baffle segments includes a first mixer baffle segment wherein the first and third planar divider baffle plates are oriented generally vertically such that the first mixer baffle segment divides the fluid flow and rotates the fluid flow counter-clockwise in the direction of flow.

13. The static mixer of claim 12, wherein the plurality of mixer baffle segments includes a second mixer baffle segment adjacent to the first mixer baffle segment, wherein the first and third planar divider baffle plates of the second mixer baffle segment are oriented generally horizontally such that the second mixer baffle segment divides the fluid flow and rotates the fluid flow clockwise in the direction of flow.

14. The static mixer of claim 11, wherein at least one of the leading edge and the trailing edge of each of the plurality of planar divider baffle plates includes a sharp dividing edge configured to facilitate division or recombination of the fluid flow.

15. The static mixer of claim 11, wherein the plurality of mixer baffle segments are disposed within a mixer conduit including an inlet end and an outlet end, and at least one of the first leading edge and the third trailing edge includes a flat rectangular dividing face configured to abut one of the inlet end or the outlet end.

16. The static mixer of claim 11, further comprising a mixer baffle segment stack including the plurality of mixer baffle segments interconnected to each other and disposed in a mixer conduit.

17. The static mixer of claim 16, wherein the plurality of mixer baffle segments are integral with each other in the mixer baffle segment stack.

18. A static mixer for mixing a fluid flow, comprising:
a plurality of mixer baffle segments disposed along a direction of flow and configured to divide and rotate the fluid flow, each of the mixer baffle segments further comprising:
a plurality of planar divider baffle plates interconnected together and extending generally parallel to the direction of flow so as to effectively divide the mixer into first, second, third, and fourth quadrants, the plurality of planar divider baffle plates including a first planar divider baffle plate including a first leading edge and a first trailing edge, a second planar divider baffle plate oriented perpendicular to the first planar divider baffle plate and including a second leading edge and a second trailing edge, the second leading edge coupled to the first trailing edge of the first planar divider baffle plate, and a third planar divider baffle plate oriented perpendicular to the second planar divider baffle plate and including a third leading edge and a third trailing edge, the third leading edge coupled to the second trailing edge of the second planar divider baffle plate; and
a plurality of planar occluding baffle plates interconnected to the plurality of planar divider baffle plates and extending generally perpendicular to the direction of flow so as to occlude each of the quadrants to force rotation of the fluid flow,
wherein the plurality of mixer baffle segments includes a first mixer baffle segment wherein the first and third planar divider baffle plates are oriented generally vertically such that the first mixer baffle segment divides the fluid flow and rotates the fluid flow counter-clockwise in the direction of flow, and
wherein the plurality of mixer baffle segments includes a second mixer baffle segment adjacent to the first mixer baffle segment, wherein the first and third planar divider baffle plates of the second mixer baffle segment are oriented generally horizontally such that the second mixer baffle segment divides the fluid flow and rotates the fluid flow clockwise in the direction of flow.

19. A static mixer for mixing a fluid flow, comprising:
a plurality of mixer baffle segments configured to divide and rotate the fluid flow, each of the mixer baffle segments consisting of a plurality of planar baffle plates interconnected together to form pairs of adjacent baffle plates oriented generally perpendicular to each other along adjoining edges,
wherein the plurality of mixer baffle segments define a direction of flow through the static mixer, and the plurality of planar baffle plates comprises:
a plurality of planar divider baffle plates interconnected together and extending generally parallel to the direction of flow so as to effectively divide the mixer; and
a plurality of planar occluding baffle plates interconnected to the plurality of planar divider baffle plates and extending generally perpendicular to the direction of flow so as to occlude the fluid flow, wherein each of the planar occluding baffle plates includes a flow blocking surface offset in the direction of flow from flow blocking surfaces of other planar occluding baffle plates.
